(19) United States
(12) Patent Application Publication
(10) Pub. No.: US 2009/0263774 A1
(43) Pub. Date: Oct. 22, 2009

(54) Radiopaque Artificial Tooth

(75) Inventors: Penelope PICHARDO, Bayside, NY (US); Phillip LIBRACH, Syosset, NY (US); Fikret LJUJKOVIC, Flushing, NY (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: COLUMBIA DENTOFORM CORPORATION, Long Island City, NY (US)

(21) Appl. No.: 12/414,270

(22) Filed: Mar. 30, 2009

Related U.S. Application Data
(60) Provisional application No. 61/072,136, filed on Mar. 28, 2008.

(51) Int. Cl. G09B 23/28

(52) U.S. Cl. 434/263

(57) ABSTRACT

An artificial tooth is provided that mimic the essential features of natural a tooth for use in training dental professionals. The artificial tooth is a radiopaque artificial tooth that is capable of providing for anatomically correct contrast on a radiograph. The artificial tooth also mimics the hardness, debris characteristics, and anatomical features of a natural tooth. A dental training device is also provided that includes a support structure generally configured as a mouth or jaw that supports radiopaque artificial teeth.

### CROSS-REFERENCE TO RELATED APPLICATIONS

This application is entitled to and claims the benefit of the priority pursuant to 35 U.S.C. § 119(e) of U.S. Provisional Patent Application No. 61/072,136, filed Mar. 28, 2008, the disclosure of which is hereby incorporated herein by reference.

### BACKGROUND OF THE INVENTION

The present invention generally relates to an artificial tooth. In particular, the present invention relates to a radiopaque artificial tooth that is capable of showing various anatomical features on a radiograph with anatomically correct contrast.

Artificial teeth are typically used as educational tools, for example, to train dental professionals in various techniques associated with dental care. Artificial teeth are also often used in conjunction with a holder or support structure to simulate the human jaw so as to produce a life-like setting. However, conventional artificial teeth are deficient in that they do not exactly mimic all of a natural tooth's (e.g., a human tooth) features, such as hardness, anatomical features, and radiopacity. As such, conventional artificial teeth cannot, for example, be x-rayed to produce a radiograph that sufficiently simulates a radiograph of a natural tooth to show all the various anatomical features, bone architecture, and bone density. This is particularly important with respect to the ability to evaluate a dental trainee's skill in various procedures based on radiographs of artificial teeth upon which practice procedures have been completed.

Accordingly, there is still a need for an artificial tooth that can realistically simulate the natural tooth anatomy, such that it can be x-rayed to produce a life-like radiograph with anatomically correct contrast. The present invention satisfies this need.

### BRIEF SUMMARY OF THE INVENTION

Briefly stated, the present invention comprises an artificial tooth that includes a radiopaque crown and a radiopaque dentin positioned at least partially within to the radiopaque crown. The radiopaque crown and radiopaque dentin are configured to produce an anatomically correct contrast on a radiograph.

In another aspect, the present invention comprises a radiopaque artificial tooth that includes a crown formed from a composition comprised of about 12% to 20% v/v barium sulfate and a dentin positioned proximate the crown. The dentin is formed from a composition comprised of about 8% to 12% v/v barium sulfate.

In yet another aspect, the present invention comprises an artificial tooth that includes a crown formed from a composition having barium sulfate at a concentration sufficient to produce an anatomically correct contrast on a radiograph and a dentin proximate the crown. The dentin is formed from a composition having barium sulfate at a concentration sufficient to produce an anatomically correct contrast on a radiograph. The dentin also includes an internal endodontic canal.

In another aspect, the present invention comprises a dental training device that includes a support structure configured as a human maxilla or mandible and a plurality of radiopaque artificial teeth supported by the support structure. The radiopaque artificial teeth are configured to produce an anatomically correct contrast on a radiograph.

### BRIEF DESCRIPTION OF THE SEVERAL VIEWS OF THE DRAWINGS

The following detailed description of the preferred embodiments of the present invention will be better understood when read in conjunction with the appended drawings. For the purposes of illustrating the invention, there are shown in the drawings embodiments which are presently preferred. It is understood, however, that the present invention is not limited to the precise arrangements and instrumentalities shown. In the drawings:

FIG. 1 is a posterior elevational view of a radiopaque artificial incisor tooth in accordance with a preferred embodiment of the present invention;

FIG. 2 is a side elevational view of a radiopaque artificial molar tooth in accordance with another preferred embodiment of the present invention;

FIG. 3 is a radiographic side elevational view of the radiopaque artificial molar tooth of FIG. 2;

FIG. 4 is a conventional radiographic side elevational view of a natural tooth; and

FIG. 5 is a perspective view of a dental training device having artificial teeth in accordance with the embodiments of the present invention.

### DETAILED DESCRIPTION OF THE INVENTION

Reference will now be made in detail to the present examples of the invention illustrated in the accompanying drawings. Wherever possible, the same or like reference numbers will be used throughout the drawings to refer to the same or like portions. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. Such directional terms used in conjunction with the following description of the drawings should not be construed to limit the scope of the invention in any manner not explicitly set forth.

As used herein, the term “anatomically correct contrast” can be defined as the resolution (e.g., shades of grey or grayscale resolution) on radiographs exhibited by natural bone structures upon being x-rayed. Accordingly, as applied to natural teeth, anatomically correct contrast is the resolution of anatomical structures exhibited on a radiograph from x-rays of natural teeth. For example, FIG. 4 is a radiograph of natural teeth. The various anatomical features of the natural tooth (such as the crown 52′ and dentin 54′) vary in density, as such a radiographic image of such anatomical features will appear lighter or darker on a radiograph. This anatomically ordered compilation of lighter and darker images represents the anatomically correct contrast as defined herein.

A radiographic image is formed by a controlled burst of x-ray radiation which penetrates oral structures at different levels, depending on varying anatomical densities, before striking the film or sensor. Teeth appear lighter because less radiation penetrates them to reach the film. Dental caries, tooth decay, infections and other changes in the bone density, and the periodontal ligament, appear darker because x-rays readily penetrate these less dense structures. Various anatomical features of natural teeth, such as the crown and dentin also vary in density thereby appearing lighter or darker on a radiographic image. These radiographic images of natural teeth's various anatomical features define the anatomically correct contrast on the radiograph, such as for the crown and dentin. It is important to note that anatomically correct contrast refers to both the contrast/resolution and the proper anatomical relations of such contrast/resolution.

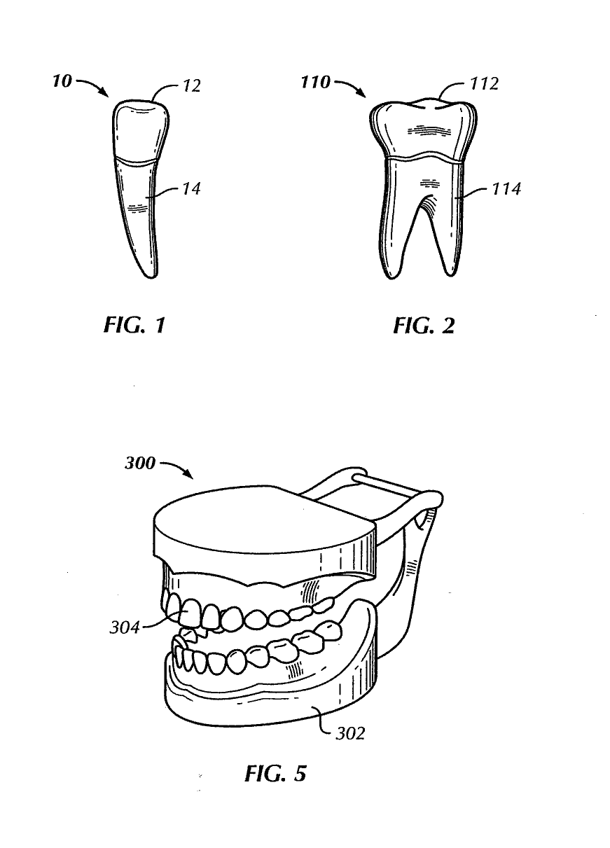

There is shown in FIGS. 1 and 2, preferred embodiments of a radiopaque artificial tooth 10, 110. Similar to natural teeth, the artificial tooth 10 includes a crown 12 and a dentin 14 inferior to the crown 12. The artificial tooth 10 can generally be configured to simulate the hardness, radiopacity and anatomical features of any tooth, such as all thirty-two (32) human teeth or any animal tooth. Such anatomical features include, but are not limited to, the crown, crown horns, root(s), enamel layer, dentin layer, and internal endodontic canal.

As shown in FIG. 1, the artificial tooth 10 is configured as an incisor tooth 10 that includes a crown 12 and a dentin 14. The dentin 14 is positioned at least partially within the crown 12, proximate to the crown 12, or inferior to the crown 12. As shown in FIG. 2, the artificial tooth 110 is configured as a molar tooth 110 that includes a crown 112 and a dentin 114.

The artificial tooth 10 is also configured to be radiopaque such that the various anatomical features of the artificial tooth 10 are visible on a radiograph as they would be for a radiograph of a natural tooth. That is, e.g., the crown 12 would be a radiopaque crown and the dentin 14 would be a radiopaque dentin. The various components or architecture forming the anatomical features of the artificial tooth 10 are composed of a specific composition to impart the required degree of radiopacity and bone-like physical properties to more accurately depict what a natural tooth would feel like, and appear like on a radiograph.

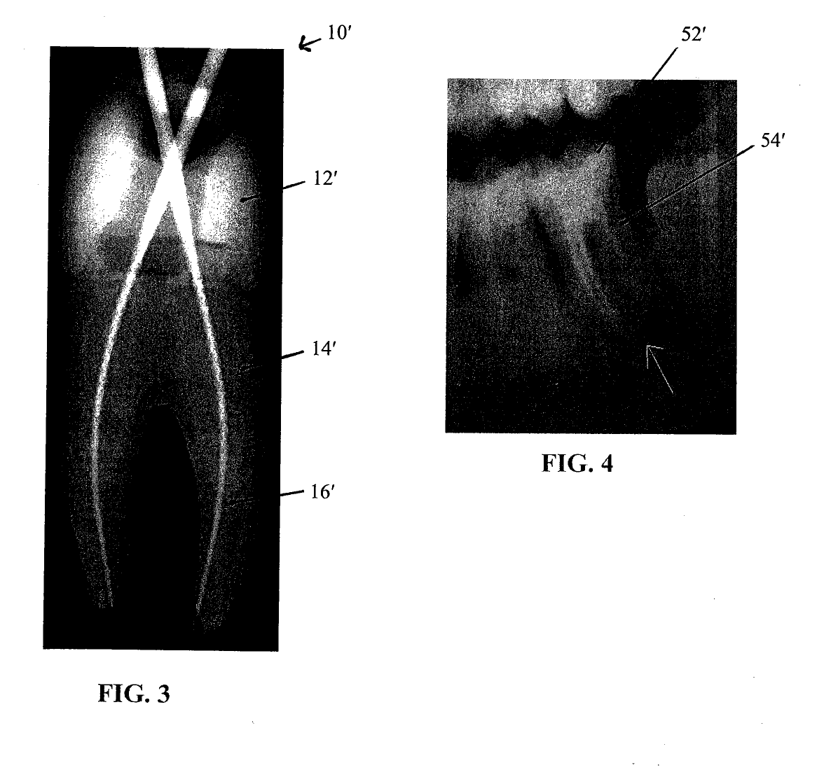

In addition, the artificial tooth 10 is structurally configured to depict various anatomical features, such as the crown 12 and dentin 14, on a radiograph in the proper anatomical configuration. That is, the crown 12 of the artificial tooth 10 is layered with respect to the dentin 14. As such, upon being x-rayed (as shown in FIG. 3), the crown 12′ and dentin 14′ layers of the artificial tooth 10′ would appear visible on a radiograph with the anatomically correct contrast to accurately represent such radiographed features of a natural tooth.

The crown 12 is composed of a composition that includes a melamine molding compound such as Ivorine™ from Perstorp Compounds, Inc. of Florence, Mass. The melamine molding compound has physical and chemical properties similar to that of a natural tooth's crown when molded. That is, the crown 12 of the artificial tooth 10 has, for example, a substantially equivalent hardness compared to the crown of a natural tooth. Moreover, the crown 12 has debris characteristics substantially the same as for the crown of a natural tooth. That is, upon being drilled, the crown 12 will debris in a similar fashion to that of a natural tooth's crown upon being drilled. As a result, the crown 12 can provide the hardness encountered by dental professionals working on the natural tooth to provide for a realistic training tool without having to resort to training on actual patients.

The crown's composition also includes a radiocontrasting agent. The radiocontrasting agent is preferably barium sulfate, which is an insoluble radiocontrasting agent. The barium sulfate is added to the crown's composition in an amount sufficient to provide the required degree of radiopacity to the crown 12 for an anatomically correct contrast on a radiograph. Preferably the concentration of barium sulfate added is about 12 to 20% volume/volume (v/v). Moreover, as a highly insoluble material, barium sulfate is safer than most other forms of barium. Thus, the artificial tooth 10 is safer for repeated use by dental professionals who may be exposed to debris generated from conventional artificial teeth, such as where the artificial tooth is used in the training of root canal procedures where drilling of the crown may be involved.

The dentin 14 is composed of a composition that includes an epoxy (such as epoxy #20-136 from Smooth-On of Easton, Pa.) and a radiocontrasting agent. The epoxy has physical and chemical properties similar to that of a natural tooth's root when molded. That is, the dentin 14 of the artificial tooth 10 has, for example, a substantially equivalent hardness compared to the dentin of a natural tooth. As such, similar to the crown 12, the artificial tooth's dentin 14 can provide for a hardness encountered by dental professionals to more accurately represent to the hardness of a natural tooth's dentin as much as possible to provide for a realistic training tool. The radiocontrasting agent is preferably barium sulfate and more preferably, barium sulfate at a concentration from about 8 to 12% v/v barium sulfate. While the present embodiment has been described with reference to barium sulfate as the preferred radiocontrasting agent, it is within the intent and scope of the present invention that other materials capable of providing the appropriate radiopacity can be used.

In addition, the dentin 14 is structurally configured to depict and represent various anatomical features of a natural dentin. For example, the dentin 14 is positioned at least partially within the crown 12, proximate the crown 12, or inferior to the crown 12. The dentin 14 can optionally include an endodontic canal 16′ (as shown in FIG. 3). Thus, upon being x-rayed, the dentin 14′ and the endodontic canal 16′ would appear visible on a radiograph with the anatomically correct contrast to represent such radiographed features of a natural tooth.

The inventors of the present invention have surprisingly discovered that the combination of specific quantities of a radiocontrasting agent, such as barium sulfate with the crown or dentin compositions, advantageously results in a radiographic image having essentially anatomically correct contrast, as shown in FIGS. 3 and 4. The artificial tooth 10′ (FIG. 3) exhibits anatomical features and radiographic contrast similar to that of the natural tooth (FIG. 4). Therefore, in addition to providing proper anatomical features, hardness, and debris characteristics of natural teeth, the present invention also provides a means to properly assess the quality of a dental procedure performed on the artificial tooth 10 by allowing for such artificial teeth to be radiographed with anatomically correct contrast.

In manufacturing the artificial tooth 10, the crown 12 and dentin 14 are molded into the desired tooth shape, such as an incisor, canine, premolar, or molar tooth. The artificial tooth 10 can be molded by any conventional molding process readily known in the art and a detailed description of such molding equipment and process operations, functions, and/or structures is not necessary for a complete understanding of the present invention. However, exemplary molding processes applicable to the present invention include compression molding, injection molding, and cast molding.

As shown in FIG. 3, an artificial tooth 10′ is configured with a crown 12′ layered on a dentin 14′. The dentin 14′ of the artificial tooth 10′ can also be configured with an endodontic canal or root canal 16′ which is configured to simulate the endodontic canal of a natural tooth. The endodontic canal 16′ can be manufactured by positioning a pin in the mold where the endodontic canal is to be located.

The artificial tooth 10′ has sufficient radiopacity to allow its various anatomical features, such as the crown 12′ and dentin 14′ to be visible on the radiograph with essentially anatomically correct contrast. In comparison to a conventional artificial tooth (not shown), this provides significant advantages as conventional artificial teeth would not be readily visible on a radiograph nor would such conventional artificial teeth provide for anatomically correct contrast.

In sum, the present embodiment advantageously provides for an artificial tooth 10 that more accurately simulates the anatomical features of natural teeth, such as the appearance and internal anatomy. In addition, the artificial tooth 10 more accurately simulates natural teeth's physical properties, such as bone-like hardness, density and radiopacity to provide for anatomically correct contrast upon being x-rayed. That is, a natural tooth varies in density throughout its entire structure. As such, a natural tooth exhibits varying levels of radiopacity depending upon the density of the natural tooth at a particular location. For example, the crown is denser than the dentin layer. Thus, the artificial tooth 10 of the present invention advantageously provides for an artificial tooth that simulates the radiopacity of a natural tooth throughout its entire architecture.

Furthermore, the artificial tooth 10 advantageously provides for a more real life-like experience for training dental professionals in dental procedures. For example, as a result of the artificial tooth's 10 radiopacity and bone-like properties, dental faculty and educators can evaluate a dental trainee's skill with a higher level of accuracy of the working length of the tooth by being able to exam the dental trainee's work via radiographs. Moreover, a dental trainee's skill in procedures such as root canals, where the placement of the master point and final obturation are crucial, can also be better assessed due to the realistic and radiopacity features of the artificial tooth 10. This further allows dental training professionals to practice on a tooth where they can see their performance immediately rather than having, for example, to obturate in the “blind.”

Referring now to FIG. 5, there is shown a dental training device 300 that can be used to assist in the training of students in, for example, the taking of x-rays of human teeth and bone and other related oral structures. The dental training device 300 includes a support structure 302 and radiopaque artificial teeth 304 in accordance with the above embodiment. Preferably, the dental training device 300 includes a plurality of radiopaque artificial teeth 304 by type or in sections of teeth, and more preferably including all thirty two (32) teeth of the human mouth. The radiopaque artificial teeth 304 can be fastened to the support structure 302 with radiolucent lingual plastic screws or similar radiolucent fasteners (not shown), or any suitable adhesive, such as an epoxy, self-etching adhesive materials, and the like.

The support structure 302 is preferably configured to simulate the alveolar bone or the maxilla or mandible. Such support structures are well known in the art and a detailed description of their operation, function, and structure is not necessary for a complete understanding of the present embodiment. However, exemplary support structures include the Ivorine Dentoform Models, manikins, and dental hygiene models available from Columbia Dentoform of Long Island City, N.Y. The alveolar bone is a thickened ridge of bone that contains the tooth sockets also referred to as the maxilla or mandible. The maxilla is a fusion of two bones along the palatal fissure that form the upper jaw. The mandible is a fusion of two halves at the mental symphysis.

Together, the support structure 302 and plurality of radiopaque artificial teeth 304 form an anatomically correct manikin which allows a student to train on, for example, in the taking of x-rays of the human mouth. The dental training device 300 also advantageously allows for evaluation of the quality of the radiograph taken by allowing the student and trainers to view the radiopaque artificial teeth on a radiograph, which advantageously provides for anatomically correct contrast.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. For instance, the present invention is not limited to the teeth 10, 110 in any particular support structure.

What is claimed is:

1. An artificial tooth comprising:
a radiopaque crown; and
a radiopaque dentin positioned at least partially within to the radiopaque crown,
wherein the radiopaque crown and radiopaque dentin are configured to produce an anatomically correct contrast on a radiograph.

2. The artificial tooth of claim 1, wherein the crown and dentin is formed from a composition comprised of a radiocontrasting agent.

3. The artificial tooth of claim 2, wherein the radiocontrasting agent is barium sulfate.

4. The artificial tooth of claim 1, wherein the crown is formed from a composition comprised of about 12% to 20% v/v barium sulfate.

5. The artificial tooth of claim 1, wherein the dentin includes an endodontic canal.

6. The artificial tooth of claim 1, wherein the dentin is formed from a composition comprised of about 8% to 12% v/v barium sulfate.

7. A radiopaque artificial tooth comprising:
a crown formed from a composition comprised of about 12% to 20% v/v barium sulfate; and
a dentin positioned proximate the crown and formed from a composition comprised of about 8% to 12% v/v barium sulfate.

8. An artificial tooth comprising:
a crown formed from a composition comprised of barium sulfate at a concentration sufficient to produce an anatomically correct contrast on a radiograph;
a dentin proximate the crown and formed from a composition comprised of barium sulfate at a concentration sufficient to produce an anatomically correct contrast on a radiograph, the dentin including an internal endodontic canal.

9. A dental training device comprising:
a support structure configured as a human maxilla or mandible; and
a plurality of radiopaque artificial teeth supported by the support structure and configured to produce an anatomically correct contrast on a radiograph.

10. The dental training device of claim 9, wherein each of the plurality of radiopaque artificial teeth comprises:
a crown formed from a composition comprised of about 12% to 20% v/v barium sulfate; and
a dentin at least partially within the crown and formed from a composition comprised of about 8% to 12% v/v barium sulfate.

11. The dental training device of claim 9, wherein each of the plurality of the radiopaque artificial teeth comprises:
a crown; and
a dentin positioned inferior to the crown, the dentin including an endodontic canal.
